(19) United States
(12) Patent Application Publication
(10) Pub. No.: US 2009/0208902 A1
(43) Pub. Date: Aug. 20, 2009

(54) DENTAL DRILL MADE OF PLASTICS

(75) Inventors: Karl-Heinz DANGER, Detmold (DE); Mark JAKUBZIK, Lemgo (DE)

Correspondence Address: SHERIDAN ROSS PC, 1560 BROADWAY, SUITE 1200, DENVER, CO, 80202, US

(73) Assignee: GEBR. BRASSELER GMBH & CO. KG, Lemgo (DE)

(21) Appl. No.: 12/372,353

(22) Filed: Feb. 17, 2009

(30) Foreign Application Priority Data
Feb. 20, 2008 (DE) 102008010049.8-43

(51) Int. Cl. A61C 3/02

(52) U.S. Cl. 433/165

(57) ABSTRACT

The invention refers to a dental drill comprising a head provided with cutting edges, which has an at least rounded basic shape, wherein two of the cutting edges at the front side merge into a transitional cutting edge, characterized in that the dental drill is made of a plastics material which has a hardness between 60 and 250 Knoop.

### CROSS REFERENCE TO RELATED APPLICATIONS

Cross reference is made to German Application No. 102008010049.8-43, filed Feb. 20, 2008, entitled “DENTAL DRILL MADE OF PLASTICS” the entire disclosure of which is incorporated herein by reference.

### SUMMARY OF THE INVENTION

The invention refers to a dental drill having the features of the preamble of claim 1.

In detail, the invention refers to a dental drill having a head including cutting edges, wherein the head has at least a rounded basic form. Same may be spherical or pear-shaped, as it is pre-known from the state of the art.

The state of the art shows dental drills for preparing teeth, which are made of steel, hard metal and ceramics. Such drills are for example pre-known from 10 2006 018 933 B4.

Further, it is known from the state of the art to manufacture preparation tools of plastics. Such tools are shown in U.S. Pat. No. 006,347,941 B1 and U.S. Pat. No. 006,106,291 A, the contents of which are incorporated herein by this reference in their entireties. In contrast to such prior art disclosures, however, the present invention employs harder materials, for example, plastic materials having a hardness above about 40 Knoop, and that are suitable for use with higher speed devices.

Similar to ceramic preparation instruments, it is intended to shape the plastics preparation instruments such that exclusively diseased dentin is removed. Same is softer than sane dentin.

A typical application for such dental instruments is the excavating in case of a cavity preparation. Herein, the dental instruments are usually operated without cooling in a relatively low range of rotational speeds (<5000 min⁻¹). In order to avoid damaging or destroying of the dental pulp, it is important to use instruments which do not involve an excess generation of heat.

However, the pre-known plastics dental drills have not proven to be effective in practice.

It is an object underlying the invention to provide a dental drill of the aforementioned type, which enables an enhanced preparation of a tooth and an enhanced removal of diseased dentin during cavity preparation.

According to the invention, this object is solved by the combination of features of the main claim, the sub-claims show further advantageous embodiments of the invention.

According to the invention, it is thus provided that the dental drill is made of a plastics material which has a hardness between 60 and 250 Knoop.

The hardness of the plastics material selected according to the invention features a series of considerable advantages. The plastics material having the selected hardness is on the one hand capable of removing diseased dentin reliably, whereas sane dentin is not removed or only removed in insignificant small amounts. Therewith, the cavity preparation is considerably enhanced. In particular, there is no danger that the dentist removes too much of the sane dentin inadvertently. He may rather remove exclusively the diseased dentin at first during excavating.

The inventive plastics dental drills may be made of different plastics having the desired hardness (e.g. of at least about 40 Knoop, and more preferably between about 60 and 250 Knoop), e.g. polyoximethylene (POM), polycarbonate (PC), polyetherimide (PEI), polyethersulphone (PES), polyamidimide (PAI), polyfenilensulfone (PPSU), polyetheretherketone (PEEK) or polysulfone (PSU).

In a particularly preferred embodiment of the invention, it is provided that the plastics material is additionally reinforced with fibers, e.g. glass fiber, carbon fiber, combinations thereof, or the like.

The dental drill according the invention can be manufactured simply and at low costs. On the one hand, it is possible to manufacture same with the usual methods of plastics engineering, e.g. injection moulding. However, they can also be machined, in particular to create the drill geometry, to create or post-process the cutting edge geometry or to sharpen the cutting edges.

The inventive measure of hardness according to Knoop refers to DIN EN ISO 4545. Similar to the Vickers examination, the hardness examination according to Knoop uses a diamond peak having a rhombic shape, which has an acute angle of 172.5° for the long side and 130° for the short side.

According to the invention, it results that the dental drill is particularly suited for removing diseased dentin from cavities in case of a cavity preparation, wherein diseased dentin is removed, however, sane dentin is preserved. This is a contrast to the metal dental drills which also remove sane dentin due to the selection of the material and the geometry of the cutting edges.

By means of the design of the cutting edges, it can be achieved that the drills cut into soft or carious material and only shave over the surface and do not remove any material in case of compact, sane tooth substance. Therewith, a certain tactile feeling is obtained, through which the user receives a feedback. Same may be achieved by different cutting edge profiles as well as different cutting edge divisions and depths, such that the effective angles within one drill are possibly different.

The shape of the head is preferably round or pear-shaped. The head has a transitional cutting edge or cross cutting edge at its face side, which is formed by co-acting of two of the plurality of cutting edges. Therewith, the cutting performance as well as the guidance of the dental drill are enhanced.

According to the invention, it is possible to use different numbers of cutting edges, i.e. four, six, eight or ten cutting edges, depending on the dimensioning and shape of the head of the inventive dental drill.

It is particularly preferred that the cutting angle ranges between about 0° and about −25°. In this context, it is advantageous if the wedge angel ranges between about 40° and about 60°.

By rounding the cutting edge base as well as the transitional areas, the removed chips may be well conveyed. The cannot wedge in the chip base and therewith prevent that additional friction heat is generated. This results in an enhanced excavating performance of the inventive dental drill. The cutting edges themselves are however sharp and have a cutting edge tip in the cross-section.

### BRIEF DESCRIPTION OF THE DRAWINGS

In the following, the invention is explained based on embodiments in combination with the drawing, in which:

FIG. 1 shows a schematic side view of an inventive dental drill having a substantially spherical head.

FIG. 2 shows a side view, analogous to FIG. 1, with a substantially pear-shaped head.

FIGS. 3 and 4 show front side plan views onto two different embodiments.

FIGS. 5 and 6 show sectional views in the radial plane of the embodiments shown in FIGS. 3 and 4.

### DETAILED DESCRIPTION OF THE INVENTION

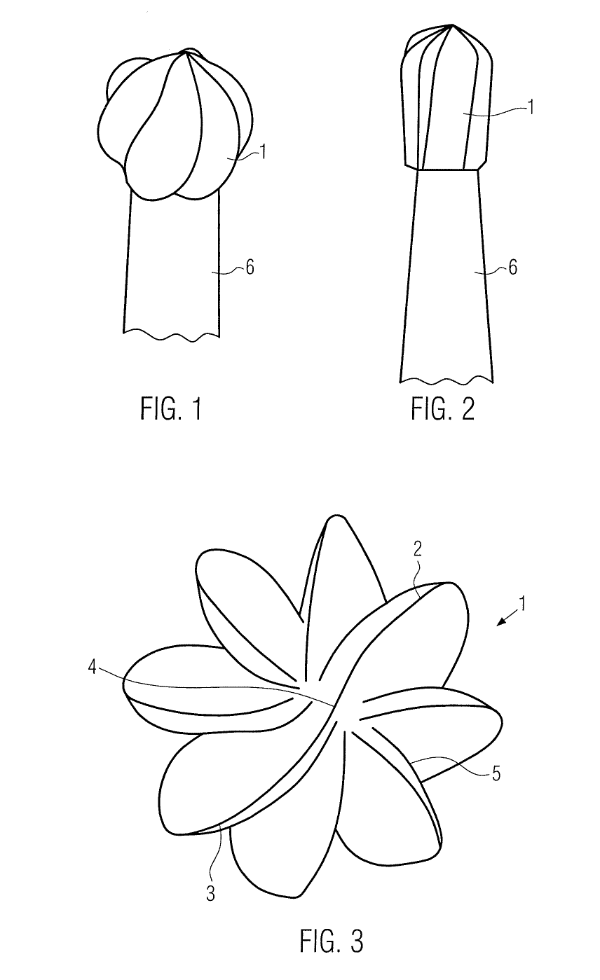

As results from FIGS. 1 and 2, the inventive dental drill comprises a head 1 which is attached at a shaft 6 and is integrally connected thereto. The number of cutting edges as well as the shape of the head depend on the respective purpose of application and the respective design. FIG. 1 shows a substantially spherical head, whereas the head according to FIG. 2 is substantially pear-shaped.

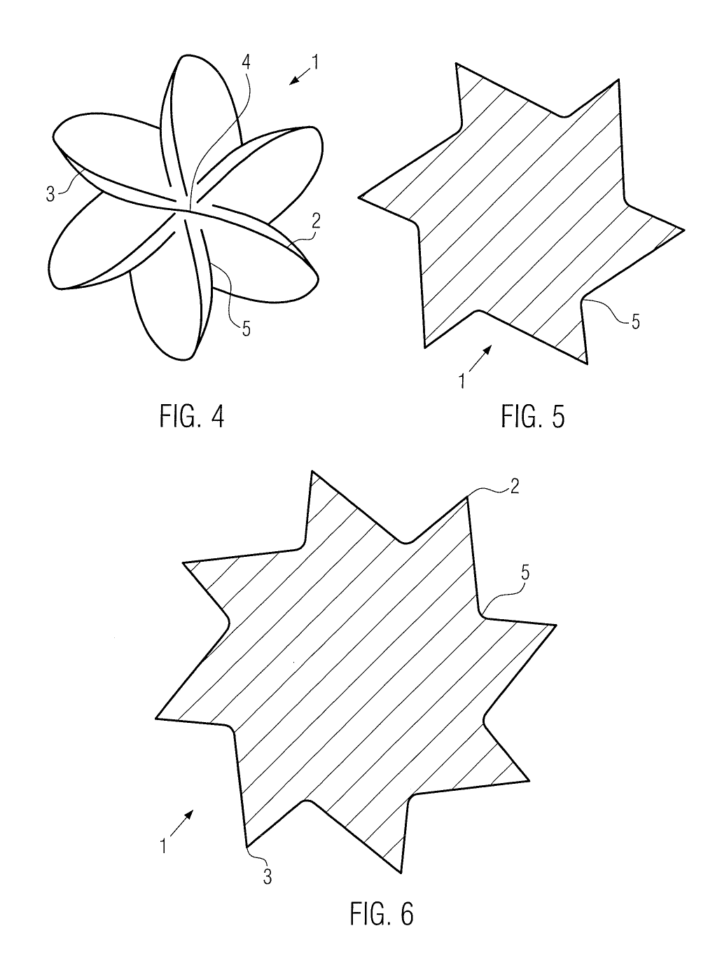

FIGS. 3 and 4 respectively show front side views of two different embodiments. The embodiment of FIG. 3 comprises a total of eight cutting edges. Therein, the two cutting edges 2, 3 are formed such that they merge into each other at the front side and form a transitional cutting edge or cross cutting edge 4.

In the embodiment of FIG. 4, a total of six cutting edges is provided, wherein also the cutting edges designated with reference numerals 2 and 3 merge into a transitional cutting edge or cross cutting edge 4.

FIGS. 5 and 6 respectively show sectional views in the radial plane (with respect to the rotary axis of the dental drill). FIG. 5 corresponds to the embodiment of FIG. 4, whereas FIG. 6 corresponds to the embodiment of FIG. 3. According to the invention, it is provided that the cutting edge base 5 has a radius between 0.03 and 0.12 mm. Consequently, the transitional areas are rounded, which reduces notch stress and prevents the adhesion of chips during operation.

### LIST OF REFERENCE NUMERALS

1 head

2 cutting edge

3 cutting edge

4 transitional cutting edge/cross cutting edge

5 cutting edge base

6 shaft

1. A dental drill comprising a head having a rounded basic shape, and at least two cutting edges at a front side that merge into a transitional cutting edge, said dental drill comprising plastic having a hardness between 60 and 250 Knoop.

2. The dental drill of claim 1, wherein said plastic is polyoximethylene (POM).

3. The dental drill of claim 1, wherein said plastic is polycarbonate (PC).

4. The dental drill of claim 1, wherein said plastic is polyetherimide (PE).

5. The dental drill of claim 1, wherein said plastic is polyethersulfone (PES).

6. The dental drill of claim 1, wherein said plastic is polysulfone (PSU).

7. The dental drill of claim 1, wherein said plastic is polyamidimide (PAI).

8. The dental drill of claim 1, wherein said plastic is polyfenilensufone (PPSU)

9. The dental drill of claim 1, wherein said plastic is polyetheretherketone (PEEK).

10. The dental drill of claim 1, wherein the plastic is reinforced with fibers.

11. The dental drill of claim 1, wherein the at least two cutting edges are formed such that the dental drill cuts into soft material and does not remove any material in case of compact tooth substance.

12. The dental drill of claim 1, wherein the drill has at least one cutting angle between about 0° and about −25°.

13. The dental drill of claim 1, wherein the drill has at least one wedge angle between about 40° and about 60°.

14. The dental drill of claim 1, wherein the drill has four cutting edges.

15. The dental drill of claim 1, wherein the drill has six cutting edges.

16. The dental drill of claim 1, wherein the drill has eight cutting edges.

17. The dental drill of claim 1, wherein the drill has ten cutting edges.

18. The dental drill of claim 1, wherein the head has a pear-shaped contour.

19. The dental drill of claim 1, wherein the drill has no transitional cutting edge.

20. A dental drill comprising a head having a rounded basic shape and at least two cutting edges at a front side that merge into a transitional cutting edge, said head consisting essentially of plastic material having a hardness of at least 40 Knoop.
